(19) United States
(12) Patent Application Publication
(10) Pub. No.: US 2012/0036497 A1
(43) Pub. Date: Feb. 9, 2012

(54) INTEGRITY CHECK WHILE COMMITTING CHANGES FROM AN INTEGRATED DEVELOPMENT ENVIRONMENT TO A SOURCE CODE CONTROL SYSTEM

(75) Inventors: Augustus Karthik, Tamil Nadu (IN); Subhasis Khatua, Pin (IN)

(73) Assignee: COMPUTER ASSOCIATES THINK, INC., Islandia, NY (US)

(21) Appl. No.: 12/852,814

(22) Filed: Aug. 9, 2010

(51) Int. Cl. G06F 9/44; G06F 17/30

(52) U.S. Cl. 717/122

(57) ABSTRACT

Integrity check is performed on selected items that are to be committed to storage from an integrated development environment. Integrity check utilizes dependency relationship table to determine implicit changes in items occurring due to explicit changes made to the related items.

### FIELD

The present disclosure relates generally to computer system and software, and more particularly to performing integrity check while committing changes from an integrated development environment (IDE) or the like to source code control (SCC) system or the like.

### BACKGROUND

Integrated development environment (IDE) is a software application that provides computer programmers or the like with supporting components or tools for building a program or software. An example of such IDE is Visual Studio™ from Microsoft™. Such IDEs may include code editor for writing and editing a program code or application code, a compiler for compiling and running the program code, a debugger for debugging the program code, and other support and tools for designing and developing software. A source code control (SCC) system stores source code (program code) and maintains different versions of such source code by managing changes to the documents (source code).

Many program codes developed through the IDE are organized into modularized computer files, for example, in hierarchical arrangements, for instance, having parent-child relationships. For instance, a group of related computer program code files may be placed under one container (or a directory). A container file may include one or more containers or files.

As changes are made to the program code or other files edited through the IDE, the IDE commits (stores) the changed code or files via a SCC system to a repository or the like which the SCC system maintains.

For example, Visual Studio™ from Microsoft™ provides Solution-Project-File hierarchy in which Solution (e.g., container) contains one or more projects, and Project (container) contains one or more files. Changes such as rename, move, delete, add operations performed on a file results in implicit edit in corresponding project file (container) in software or applications. Similarly, explicit changes (e.g., rename, delete, and add) made to a project causes implicit edit in corresponding solution file (container). However, in current IDE commit methodologies, uses may commit or save one or more files without selecting also to commit or save the related files that are affected by the changed files. Such methodologies may cause integrity problem and other build problems.

### BRIEF SUMMARY OF THE INVENTION

A method and system for performing an integrity check in committing changes from an integrated development environment to a source code control system are provided. The method, in one aspect, may include creating a dependency relationship table listing one or more child items that have changed and whose changes caused implicit changes to a parent item, the dependency relationship table further including the parent item and associating of the one or more child items with the parent item. The method also may include identifying one or more items selected for commit operation in an integrated development environment. The method further may include determining using the dependency relationship table whether said one or more selected items have explicit changes that create implicit changes in one or more second items. The method yet further may include determining whether said one or more second items having implicit changes are included in the identified one or more selected items, in response to determining that said one or more selected items have explicit changes that create implicit changes in one or more second items. The method further still may include allowing the commit operation to proceed in response to determining that said one or more second items having implicit changes are in the identified one or more selected items, and blocking the commit operation in response to determining that said one or more second items having implicit changes are not included in the identified one or more selected items.

In another aspect, the creating of a dependency relationship table may include detecting an explicit change made to a current child item in the integrated development environment, and determining whether the explicit change is of a type that causes an implicit change in a container item associated with the current child item. The creating of the dependency relationship table may also include checking the dependency relationship table for an entry associated with the container item, in response to determining that the explicit change is of a type that causes an implicit change in a container item associated with the current child item. If an entry associated with the container item does not exist in the dependency relationship table, the creating of a dependency relationship table may include inserting the container item and the current child item in the dependency relationship table. If an entry associated with the container item exists in the dependency relationship table, the creating of a dependency relationship table may include retrieving one or more child items listed under the container item in the dependency relationship table, and if the one or more child items listed under the container item does not include the current child item, adding the current child and associating the current child item with the entry of the container item in the dependency relationship table.

A system for performing an integrity check in committing changes from an integrated development environment to a source code control system may include a dependency relationship table listing one or more child items that have changed and whose changes caused implicit changes to a parent item, the dependency relationship table further including the parent item and associating of the one or more child items with the parent item. A module may be operable to create the dependency relationship table, the module further operable to identify one or more items selected for commit operation. The module further may be operable to determine using the dependency relationship table whether said one or more selected items have explicit changes that create implicit changes in one or more second items. The module also may be operable to determine whether said one or more second items having implicit changes are included in the identified one or more selected items in response to determining that said one or more selected items have explicit changes that create implicit changes in one or more second items. The module further may be operable to allow the commit operation to proceed in response to determining that said one or more second items having implicit changes are in the identified one or more selected items, and to block the commit operation in response to determining that said one or more second items having implicit changes are not included in the identified one or more selected items.

In another aspect, the module of the system for performing an integrity check in committing changes from an integrated development environment to a source code control system may be operable to create the dependency relationship table by detecting an explicit change made to a current child item in the integrated development environment. The module further may determine whether the explicit change is of a type that causes an implicit change in a container item associated with the current child item. The module also may check the dependency relationship table for an entry associated with the container item, in response to determining that the explicit change is of a type that causes an implicit change in a container item associated with the current child item. If an entry associated with the container item does not exist in the dependency relationship table, the module further may insert the container item and the current child item in the dependency relationship table. If an entry associated with the container item exists in the dependency relationship table, the module also may retrieve one or more child items listed under the container item in the dependency relationship table. If the one or more child items listed under the container item does not include the current child item, the module further may add the current child and associate the current child item with the entry of the container item in the dependency relationship table.

A computer readable storage medium storing a program of instructions executable by a processor to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating creation of dependency relationships among files and folder for determining related changes.

FIG. 2 is a flow diagram illustrating an integrity check performed during commit operation in one embodiment of the present disclosure.

FIG. 3 is a flow diagram illustrating detailed logic flow of the integrity check in one embodiment of the present disclosure.

FIG. 4 shows an example of a dependency relationship table.

FIG. 5 illustrates an example computer system that may implement the system and/or method of the present disclosure.

### DETAILED DESCRIPTION

In any IDE, where there are containers to hold children, a child item can be a file, folder or another container itself. A container has an inventory file to hold information about its children such as the name of a child, location of the child in file system, and others. A container is also referred to as a container item in the present disclosure. An item in the present disclosure refers to a file, folder, a container, or the like in a file organization structure, for example, in an IDE. A parent item may be a folder or directory file that can include other files. That is, a parent item has child items.

Whenever there is an explicit change made to a child, there may be an implicit change to the corresponding container (the container that the child is contained in), even if the user does not explicitly change the container or the container information. The explicit change(s) made to a child and implicit change(s) caused to the container as a result of the explicit changes are considered as “related changes”. The present disclosure discloses system(s) and method(s) that provide integrity check so that while committing such changes to any Source Code Control (SCC) system, these “related changes” are committed together. Commit or committing herein refers to saving or storing a new item or existing item, for example, in a Source Code Control (SCC) system.

In one aspect of the present disclosure, the change information (dependency relationship data) are kept or stored in a table that holds container information as the key (index) and a list of changed children (under that container) as the value. While committing some selected items from IDE to SCC system, the system and method may validate the selection against the dependency relationship data that are maintained in the present disclosure.

For example, if a child is selected for commit and corresponding container is not selected at the same time, the integrity check of the present disclosure in one embodiment will block the commit operation from completing and the selected changes will not be committed into the SCC system.

As another example, if a container is selected for a commit, but some children under the container having “related changes” are not selected for the commit, the integrity check of the present disclosure in one embodiment will block the commit operation to complete and selected changes will not be committed into the SCC system.

Yet as another example, if a container and all its “related changes” are also selected for commit, the integrity check of the present disclosure in one embodiment will not block the commit operation and the selected changes will be committed into the SCC system.

In the above examples, the present disclosure also provides provisions for finding out the required files, which were not selected and for which the commit operation was blocked.

The integrity check of the present disclosure in one embodiment may be implemented in a plug-in for IDEs such as Microsoft™ Visual Studio™. For example, Visual Studio™ solution and project are considered as the container. Files, folders under project, projects under solution are considered as the children. Changes made to a file and/or folder under a project are updated in the corresponding project file. Changes made to a project under a solution are updated in the corresponding solution file.

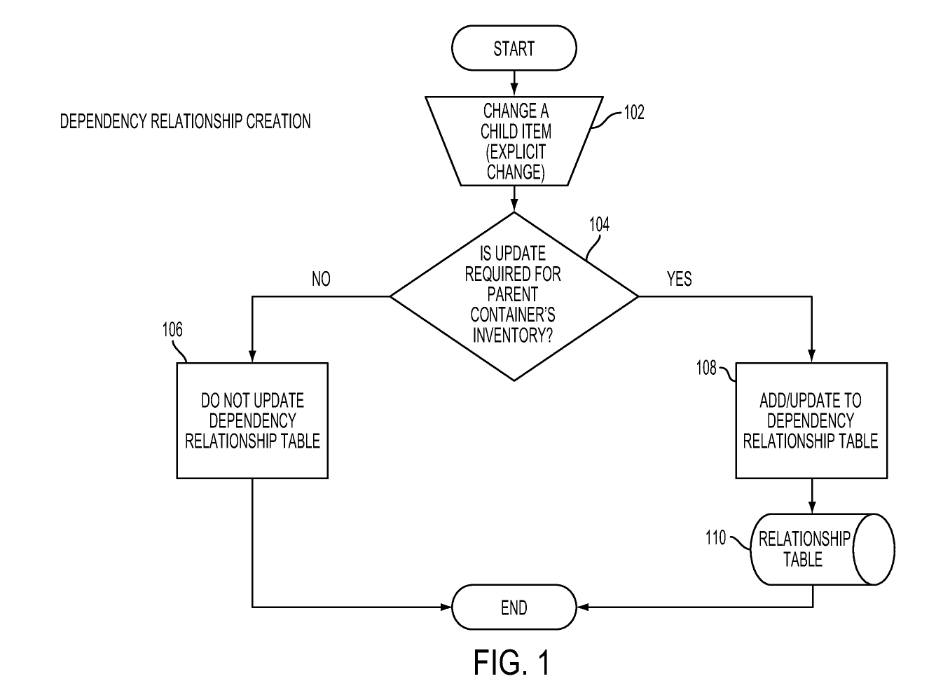

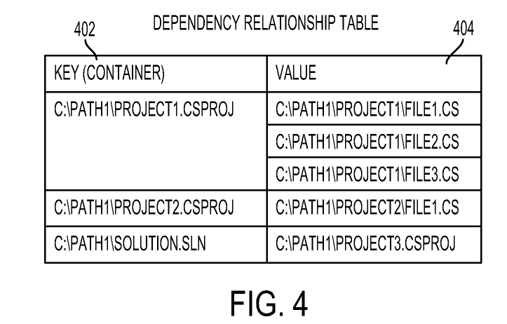

FIG. 1 is a flow diagram illustrating creation of dependency relationships among containers, files and folder for determining related changes. A dependency relationship table as described above stores information about the dependency between the files, e.g., child files and their parent containers. FIG. 4 shows an example of a dependency relationship table. In the example shown in FIG. 4, Key 402 holds information about the container file (e.g., Solution file, Project file in case of Microsoft Visual Studio IDE).

Value 404 is a list of changed files having changes of type rename, move, delete, newly added, under that container. The dependency relationship table may be of any type of data structure that can hold data that represent and associate parent to child relationship of computer files or the like, e.g., including but not limited to, hashtable, database tables, linked list, arrays, and others. The dependency relationship table may be stored in storage and/or memory device of a computer, and accessed by a processor executing the methodologies of the present disclosure.

At 102, a change made to a file is detected. The file may be, for example, a child item in a file organization hierarchy which has a parent container. A user, for example, may make explicit changes to the file, for example, by editing the file, renaming the file, changing access permission or other attributes associated with the file, and/or by making other modifications to the file. For this integrity check in one embodiment of the present disclosure, the changes that cause implicit changes to container (or parent or related folders/files) are considered. For example, the following type of changes that is made from within IDE may be considered: Rename a file, Move a file, Delete a file, Newly added a file. Those types changes when made to a file cause implicit changes in related files such as containers that the changed file is contained in. The system of the present disclosure may automatically detect that there was a change in the file. For example, in an IDE, the IDE tracks the changes made to a file and publishes those changes. The methodology of the present disclosure may be implemented as a plug-in that resides within the IDE and subscribes for those change events. The changes may be thus detected automatically in one embodiment by receiving notification of changes from the IDE.

At 104, it is determined whether an update is required for parent container's inventory. For example, the type of changes made to the file is analyzed and determined. For example, it is determined whether the change falls into the category or type of changes (e.g., rename a file, move a file, delete a file, newly added a file) that would cause an implicit change to other files. It is noted that in this disclosure, such files (that get implicit changes) are referred to as containers for simplicity. However, it should be understood that containers refer to other types of such related files, e.g., parent files in a file-directory hierarchy.

If the change made to a file is the type of change that causes an implicit change to its container, then the dependency relationship table is checked to determine whether an entry for the container is already present in the table. If there is no entry for the container, a new entry is created for the container as the key and the changed file is added as the value under the container key.

If the container is already present in the dependency relationship table, it is determined whether the changed file is in the list of files (those that have already changed) under this container. If not, the newly changed file is added to the list under this container. In this way in one embodiment, the dependency relationship table may be updated, i.e., with the new list of changed files as the new value for this container.

If at 104 no update is needed, no update is performed on the dependency relationship table as shown at 106, and the control returns to the point where the next change may be detected to repeat the process.

At 108, if an update is required, the dependency relationship table is updated, for example, with additions, deletions, and other updates as described above. At 110, an updated relationship table results.

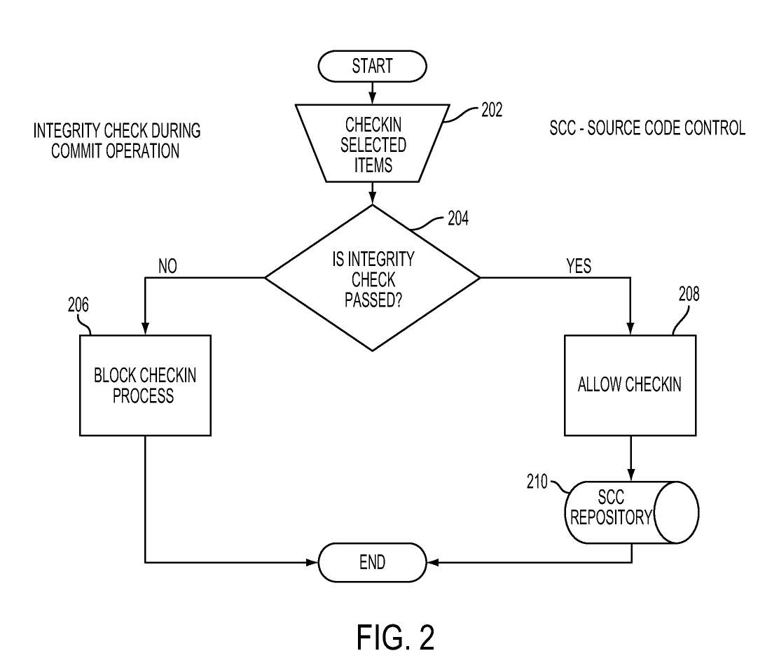

FIG. 2 is a flow diagram illustrating an integrity check performed during commit operation in one embodiment of the present disclosure. At 202, the system and method of the present disclosure may determine which items (e.g., files) are selected for commit operation, i.e., checked in for commit. For example, a user may select one or more files in an IDE user interface that lists one or more files in a project, container, or the like. At 204, it is determined whether an integrity check has passed.

At 206, if the integrity check did not pass, the committing of those selected files are blocked or prohibited. For example, the system and method of the present disclosure in one embodiment may display a message on the IDE user interface that the commit operation is not proper and would not be performed. No commit operation is performed in this case.

At 208, if the integrity check passed, the commit operation is allowed to be performed. At 210, the selected files are committed, i.e., saved in the appropriate repository, e.g., an SCC repository that stores the information and data related to the project associated with the file(s) being committed.

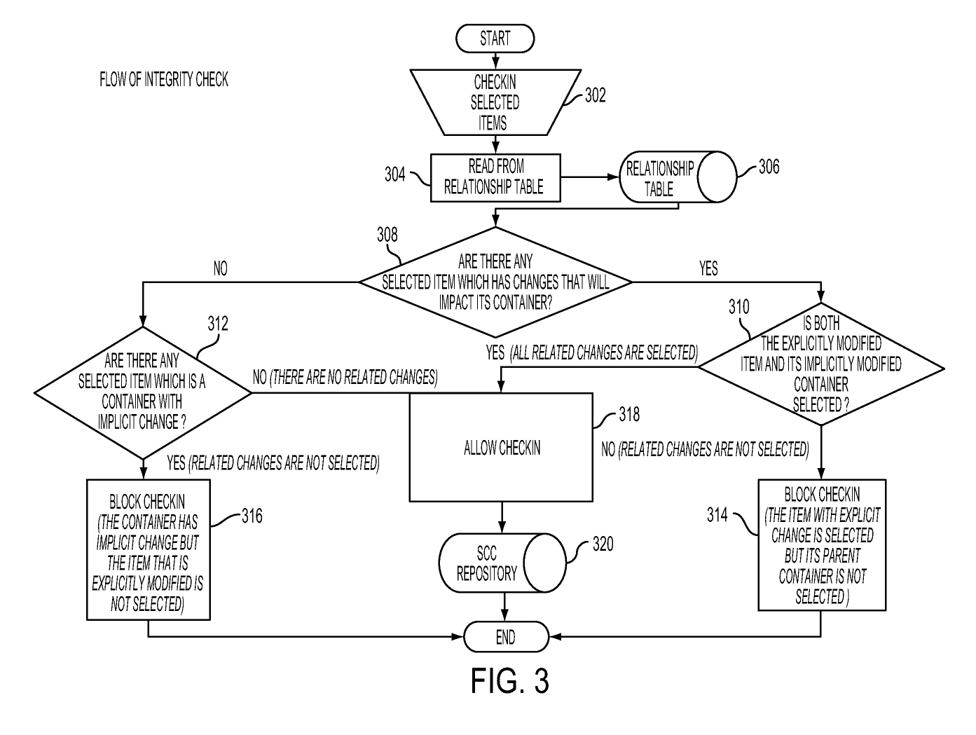

FIG. 3 is a flow diagram illustrating detailed logic flow of the integrity check in one embodiment of the present disclosure. At 302, one or more selected items (e.g., the files that are selected, for example, by a user for commit operation) are identified. At 304, the dependency relationship table 306 is accessed and read. At 308, using the dependency relationship table 306, it is determined whether there are any selected items that have changes that will impact its container. Changes to a file can be of different types. For instance, referred to as category 1 changes in the present disclosure, “rename”, “move”, “delete”, “newly added” types are changes that affect related files (e.g., container). Edits and other changes, referred to herein in the present disclosure as category 2 changes do not affect their container. At 308, it is checked whether one or more selected files have changes of type “Category 1”, for instance, by checking the dependency relationship table. For example, the dependency relationship table is searched to determine whether the selected items are in the dependency relationship table. If the selected items are in the dependency relationship table, the impacted associated item (e.g., container item having implicit changes due to the selected items being changed) is identified. For instance, as described above, in this case, the associated item and the selected items are stored as having key-value relationship in the dependency relationship table. Thus, identifying the associated item that is impacted only involves identifying the key that is related to the selected items in the dependency relationship table.

In this disclosure, the items that are affected (e.g., containers) by explicit changes made to the child files are referred to as having implicit changes. If at 308, it is determined that there are containers that are affected by the changes in the items selected for commit operation, it is determined at 310, whether both the explicitly modified item and its implicitly modified container are selected, i.e., both are in the selected items of 302. If both the explicitly changed items and implicitly changed items (i.e., those affected by the explicit changes made to other items) are selected, the commit operation is allowed to proceed at 318. The selected items are committed to the repository 320. Otherwise, at 314, the commit operation is blocked, since the item with explicit change is selected but its parent container is not selected.

If at 308, it is determined that there are no selected items that have changes that will impact its container, the control passes to step 312. If the control came to this point (i.e., step 312), it means that there may have been changes of “Category 2” (e.g., an edit) made to the selected file. At 312, for each selected changed file, it is checked if the file itself is a container. If the changed file is not a container (e.g., normal file with edit change), the control proceeds to step 318 where the commit is allowed. If the changed file is a container, that means all its dependent files are not selected. Therefore, the control proceeds to step 316 where the commit is blocked. (Block Check In/Commit).

At 318, if there are no items that are containers having implicit changes, the commit operation is allowed to be performed at 318. The selected items are saved in the appropriate repository 320.

At 316, however, if the selected item is a container but no child with explicit changes has been selected, the logic continues to 316 where the commit operation is blocked. For example, in this case, the container that is selected for commit has implicit changes but the item in the container that is explicitly modified is not selected.

In another aspect, the system and method of the present disclosure may prompt the user to select the correctly related items, if not selected together.

The various functionalities and modules of the systems and methods of the present disclosure may be implemented or carried out distributedly on different processing systems or on any single platform, for instance, accessing data stored locally or distributedly on the network.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

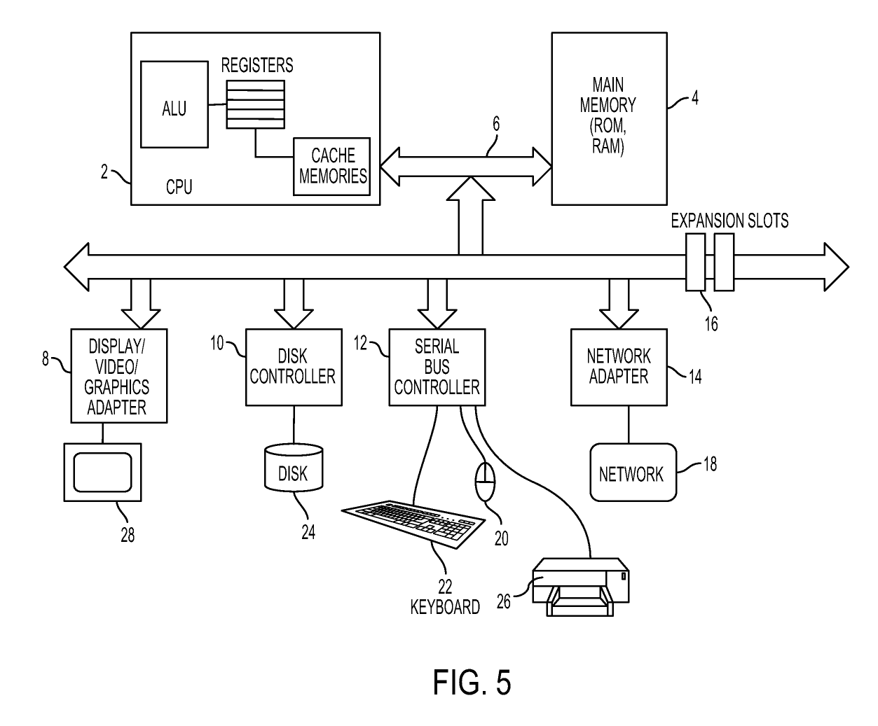

FIG. 5 illustrates an example computer system that may carry out the system and/or method of the present disclosure. One or more central processing units (CPUs) 2 may include one or more arithmetic/logic unit (ALU), fast cache memory and registers and/or register file. Registers are small storage devices; register file may be a set of multiple registers. Caches are fast storage memory devices, for example, comprising static random access (SRAM) chips. Caches serve as temporary staging area to hold data that the CPU 2 uses. Shown is a simplified hardware configuration. CPU 2 may include other combinational circuits and storage devices. One or more central processing units (CPUs) 2 execute instructions stored in memory 4, for example, transferred to registers in the CPU 2. Buses 6, for example, are electrical wires that carry bits of data between the components. Memory 4 may include an array of dynamic random access memory (DRAM) chips, and store program and data that CPU 2 uses in execution. The system components may also include input/output (I/O) controllers and adapters connected to the CPU 2 and memory 4 via a bus, e.g., I/O bus and connect to I/O devices. For example, display/graphic adapter connects 8 a monitor 28 or another display device/terminal; disk controller 10 connects hard disks 24, for example, for permanent storage; serial controller 12 such as universal serial bus (USB) controller may connect input devices such as keyboard 22 and mouse 20, output devices such as printers 26; network adapter 14 connects the system to another network, for example, to other machines. The system may also include expansion slots to accommodate other devices to connect to the system. For example, a hard disk 24 may store the program of instructions and data that implement the above described methods and systems, which may be loaded into the memory 4, then into the CPU's storage (e.g., caches and registers) for execution by the CPU (e.g., ALU and/or other combination circuit or logic). In another aspect, all or some of the program of instructions and data implementing the above described methods and systems may be accessed, and or executed over the network 18 at another computer system or device.

The methodology of the present disclosure may be implemented as methods and/or functions embedded in a computer program product, which when loaded in a computer system is able to carry out these methods and/or functions. A computer readable storage medium may be any tangible or physical medium that can store data and/or computer instructions, and that a processor or the like machine can read. Examples of a computer readable storage medium may include, but are not limited to, a computer memory such as random access memory (RAM), a read-only memory, an erasable programmable read-only memory (EPROM), and other computer memory devices, a disk, an optical storage device, and others such devices. Such medium may contain program of instructions and/or data, when read by a processor and loaded into processor memory, can carry out the methodologies of the present disclosure.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for performing an integrity check in committing changes from an integrated development environment to a source code control system, comprising:
creating, by a processor, a dependency relationship table listing one or more child items that have changed and whose changes caused implicit changes to a parent item, the dependency relationship table further including the parent item and associating of the one or more child items with the parent item;
identifying one or more items selected for commit operation in an integrated development environment;
determining using the dependency relationship table whether said one or more selected items have explicit changes that create implicit changes in one or more second items;
determining whether said one or more second items having implicit changes are included in the identified one or more selected items, in response to determining that said one or more selected items have explicit changes that create implicit changes in one or more second items;
allowing the commit operation to proceed in response to determining that said one or more second items having implicit changes are in the identified one or more selected items; and
blocking the commit operation in response to determining that said one or more second items having implicit changes are not included in the identified one or more selected items.

2. The method of claim 1, wherein the step of creating a dependency relationship table includes:
detecting an explicit change made to a current child item in the integrated development environment;
determining whether the explicit change is of a type that causes an implicit change in a container item associated with the current child item;
checking the dependency relationship table for an entry associated with the container item, in response to determining that the explicit change is of a type that causes an implicit change in a container item associated with the current child item;
if an entry associated with the container item does not exist in the dependency relationship table, inserting the container item and the current child item in the dependency relationship table; and
if an entry associated with the container item exists in the dependency relationship table, retrieving one or more child items listed under the container item in the dependency relationship table, and if the one or more child items listed under the container item does not include the current child item, adding the current child and associating the current child item with the entry of the container item in the dependency relationship table.

3. The method of claim 2, wherein if an entry associated with the container item does not exist in the dependency relationship table, the step of inserting the container item and the current child item in the dependency relationship table comprises inserting the container item as a key and the current child item as a value associated with the key in the dependency relationship table.

4. The method of claim 2, wherein the type of explicit change that causes an implicit change includes one or more of delete a file operation, rename a file operation, move a file operation, add a file operation, or combinations thereof.

5. The method of claim 1, wherein the step of determining using the dependency relationship table whether said one or more selected items have explicit changes that create implicit changes in one or more second items includes:
searching the dependency relationship table for said one or more selected items; and
if the dependency relationship table includes said one or more selected items listed and associated with one or more key values in the dependency relationship table, determining that said one or more selected items have explicit changes that create implicit changes in one or more second items, and identifying said one or more key values as the one or more second items.

6. The method of claim 1, further including:
determining by using the dependency relationship table whether said one or more selected items are container items that have implicit changes;
determining by using the dependency relationship table whether said one or more selected items include a child item that caused the implicit changes in the container items in response to determining said one or more selected items are container items that have implicit changes;
allowing the commit operation to proceed if said one or more selected items include both container items that have implicit changes and a child item that caused the implicit changes in the container items; and
blocking the commit operation if said one or more selected items do not include both container items that have implicit changes and a child item that caused the implicit changes in the container items.

7. A system for performing an integrity check in committing changes from an integrated development environment to a source code control system, comprising:
a processor;
a memory operable to store a dependency relationship table listing one or more child items that have changed and whose changes caused implicit changes to a parent item, the dependency relationship table further including the parent item and associating of the one or more child items with the parent item; and
a module operable to create the dependency relationship table, the module further operable to identify one or more items selected for commit operation, to determine using the dependency relationship table whether said one or more selected items have explicit changes that create implicit changes in one or more second items, to determine whether said one or more second items having implicit changes are included in the identified one or more selected items in response to determining that said one or more selected items have explicit changes that create implicit changes in one or more second items, the module further operable to allow the commit operation to proceed in response to determining that said one or more second items having implicit changes are in the identified one or more selected items, and to block the commit operation in response to determining that said one or more second items having implicit changes are not included in the identified one or more selected items.

8. The system of claim 7, wherein the module creates the dependency relationship table by detecting an explicit change made to a current child item in the integrated development environment;
determining whether the explicit change is of a type that causes an implicit change in a container item associated with the current child item;
checking the dependency relationship table for an entry associated with the container item, in response to determining that the explicit change is of a type that causes an implicit change in a container item associated with the current child item;
if an entry associated with the container item does not exist in the dependency relationship table, inserting the container item and the current child item in the dependency relationship table; and
if an entry associated with the container item exists in the dependency relationship table, retrieving one or more child items listed under the container item in the dependency relationship table, and if the one or more child items listed under the container item does not include the current child item, adding the current child and associating the current child item with the entry of the container item in the dependency relationship table.

9. The system of claim 8, wherein if an entry associated with the container item does not exist in the dependency relationship table, the module inserts the container item as a key and the current child item as a value associated with the key in the dependency relationship table.

10. The system of 8, wherein the type of explicit change that causes an implicit change includes one or more of delete a file operation, rename a file operation, move a file operation, add a file operation, or combinations thereof.

11. The system of claim 7, wherein the module determines whether said one or more selected items have explicit changes that create implicit changes in one or more second items by searching the dependency relationship table for said one or more selected items, and if the dependency relationship table includes said one or more selected items listed and associated with one or more key values in the dependency relationship table, the module determines that said one or more selected items have explicit changes that create implicit changes in one or more second items, and identifies said one or more key values as the one or more second items.

12. The system of claim 7, wherein the module is further operable to determine by using the dependency relationship table whether said one or more selected items are container items that have implicit changes, the module further operable to determine by using the dependency relationship table whether said one or more selected items include a child item that caused the implicit changes in the container items in response to determining said one or more selected items are container items that have implicit changes, the module further operable to allow the commit operation to proceed if said one or more selected items include both container items that have implicit changes and a child item that caused the implicit changes in the container items, and the module further operable to block the commit operation if said one or more selected items do not include both container items that have implicit changes and a child item that caused the implicit changes in the container items.

13. A computer readable storage medium storing a program of instructions executable by a processor to perform a method of performing an integrity check in committing changes from an integrated development environment to a source code control system, comprising:
creating a dependency relationship table listing one or more child items that have changed and whose changes caused implicit changes to a parent item, the dependency relationship table further including the parent item and associating of the one or more child items with the parent item;
identifying one or more items selected for commit operation in an integrated development environment;
determining using the dependency relationship table whether said one or more selected items have explicit changes that create implicit changes in one or more second items;
determining whether said one or more second items having implicit changes are included in the identified one or more selected items, in response to determining that said one or more selected items have explicit changes that create implicit changes in one or more second items;
allowing the commit operation to proceed in response to determining that said one or more second items having implicit changes are in the identified one or more selected items; and
blocking the commit operation in response to determining that said one or more second items having implicit changes are not included in the identified one or more selected items.

14. The computer readable storage medium of claim 13, wherein the step of creating a dependency relationship table includes:
detecting an explicit change made to a current child item in the integrated development environment;
determining whether the explicit change is of a type that causes an implicit change in a container item associated with the current child item;
checking the dependency relationship table for an entry associated with the container item, in response to determining that the explicit change is of a type that causes an implicit change in a container item associated with the current child item;
if an entry associated with the container item does not exist in the dependency relationship table, inserting the container item and the current child item in the dependency relationship table; and
if an entry associated with the container item exists in the dependency relationship table, retrieving one or more child items listed under the container item in the dependency relationship table, and if the one or more child items listed under the container item does not include the current child item, adding the current child and associating the current child item with the entry of the container item in the dependency relationship table.

15. The computer readable storage medium of claim 14, wherein if an entry associated with the container item does not exist in the dependency relationship table, the step of inserting the container item and the current child item in the dependency relationship table comprises inserting the container item as a key and the current child item as a value associated with the key in the dependency relationship table.

16. The computer readable storage medium of claim 14, wherein the type of explicit change that causes an implicit change includes one or more of delete a file operation, rename a file operation, move a file operation, add a file operation, or combinations thereof.

17. The computer readable storage medium of claim 13, wherein the step of determining using the dependency relationship table whether said one or more selected items have explicit changes that create implicit changes in one or more second items includes:
searching the dependency relationship table for said one or more selected items; and
if the dependency relationship table includes said one or more selected items listed and associated with one or more key values in the dependency relationship table, determining that said one or more selected items have explicit changes that create implicit changes in one or more second items, and identifying said one or more key values as the one or more second items.

18. The computer readable storage medium of claim 13, further including:
determining by using the dependency relationship table whether said one or more selected items are container items that have implicit changes;
determining by using the dependency relationship table whether said one or more selected items include a child item that caused the implicit changes in the container items in response to determining said one or more selected items are container items that have implicit changes;
allowing the commit operation to proceed if said one or more selected items include both container items that have implicit changes and a child item that caused the implicit changes in the container items; and
blocking the commit operation if said one or more selected items do not include both container items that have implicit changes and a child item that caused the implicit changes in the container items.
